(19) United States
(12) Patent Application Publication
(10) Pub. No.: US 2022/0318626 A1
(43) Pub. Date: Oct. 6, 2022

(54) META-TRAINING FRAMEWORK ON DUAL-CHANNEL COMBINER NETWORK SYSTEM FOR DIALYSIS EVENT PREDICTION

(71) Applicants: NEC Laboratories America, Inc., Princeton, NJ (US); NEC Corporation, Tokyo (JP)

(72) Inventors: Jingchao Ni, Princeton, NJ (US); Wei Cheng, Princeton Junction, NJ (US); Haifeng Chen, West Windsor, NJ (US); Takayoshi Asakura, Tokyo (JP)

(21) Appl. No.: 17/711,408

(22) Filed: Apr. 1, 2022

Related U.S. Application Data
(60) Provisional application No. 63/170,653, filed on Apr. 5, 2021.

(51) Int. Cl. G06N 3/08

(52) U.S. Cl. CPC G06N 3/08

(57) ABSTRACT

A method for performing dialysis event prediction by employing a meta-training strategy for model personalization includes, in a meta-training stage, generating segments from temporal records of patient dialysis data, generating, from the segments, a support set and a query set for each patient of a plurality of patients, formulating tasks for each patient in a pre-training set defined as a meta-training framework (M-DCCN), where each task includes the support set and the query set, and sending the tasks to a two-level meta-training algorithm supported training coordinator. The method further includes, in a finetuning stage, sending the M-DCCN to local machines where a finetuning dataset is collected for new patients, the finetuning dataset including a limited amount of data pertaining the new patients, fine-tuning the M-DCCN for personalization, and using the fine-tuned M-DCCN for future predictive dialysis analysis of future new patients by generating prognostic predictive scores.

### RELATED APPLICATION INFORMATION

This application claims priority to Provisional Application No. 63/170,653, filed on Apr. 5, 2021, the contents of which are incorporated herein by reference in their entirety.

### BACKGROUND

### Technical Field

The present invention relates to dialysis event prediction and, more particularly, to a meta-training framework on a dual-channel combiner network system for dialysis event prediction.

### Description of the Related Art

Recently, the employment of digital systems in hospitals and medical institutions has brought forth a large volume of healthcare data of patients. Big data are of substantial value, which enables artificial intelligence (AI) to be exploited to support clinical judgement in medicine. As one of the themes in modern medicine, the number of patients with kidney disease has raised social, medical and socioeconomic issues worldwide. Hemodialysis, or simply dialysis, is a process of purifying the blood of a patient whose kidneys are not working normally and is one of the important renal replacement therapies (RRT). However, dialysis patients at high risk of cardiovascular and other diseases require intensive management on blood pressure, anemia, mineral metabolism, and so on. Otherwise, patients may encounter critical events, such as low blood pressure, leg cramp, and even mortality, during dialysis. Therefore, medical staff must decide to start dialysis from various viewpoints. Some previous reports showed that variable clinical factors were related to dialysis events.

### SUMMARY

A method for performing dialysis event prediction by employing a meta-training strategy for model personalization including a dual-channel combiner network (DCCN) is presented. The method includes, in a meta-training stage, generating, via a task generator, segments from temporal records of patient dialysis data stored on a hospital database, generating, from the segments, a support set being a first subset of the patient dialysis data and a query set being a second subset of the patient dialysis data for each patient of a plurality of patients, formulating tasks for each patient of the plurality of patients in a pre-training set defined as a meta-training framework DCCN (M-DCCN) stored on a server or cloud platform, wherein each task includes the support set and the query set, and each task represents the patient dialysis data of each patient of the plurality of patients, and sending the tasks to a two-level meta-training algorithm supported training coordinator. The method further includes, in a finetuning and evaluation stage, sending the M-DCCN to local machines where a finetuning dataset is collected for new patients, the finetuning dataset including a limited amount of data pertaining the new patients, fine-tuning the M-DCCN for personalization to each of the new patients, and using the fine-tuned M-DCCN for future predictive dialysis analysis of future new patients by generating prognostic predictive scores on an incidence of dialysis events during dialysis.

A non-transitory computer-readable storage medium comprising a computer-readable program for performing dialysis event prediction by employing a meta-training strategy for model personalization including a dual-channel combiner network (DCCN) is presented. The computer-readable program when executed on a computer causes the computer to perform the steps of, in a meta-training stage, generating, via a task generator, segments from temporal records of patient dialysis data stored on a hospital database, generating, from the segments, a support set being a first subset of the patient dialysis data and a query set being a second subset of the patient dialysis data for each patient of a plurality of patients, formulating tasks for each patient of the plurality of patients in a pre-training set defined as a meta-training framework DCCN (M-DCCN) stored on a server or cloud platform, wherein each task includes the support set and the query set, and each task represents the patient dialysis data of each patient of the plurality of patients, and sending the tasks to a two-level meta-training algorithm supported training coordinator. The computer-readable program when executed on a computer causes the computer to perform the steps of, in a finetuning and evaluation stage, sending the M-DCCN to local machines where a finetuning dataset is collected for new patients, the finetuning dataset including a limited amount of data pertaining the new patients, fine-tuning the M-DCCN for personalization to each of the new patients, and using the fine-tuned M-DCCN for future predictive dialysis analysis of future new patients by generating prognostic predictive scores on an incidence of dialysis events during dialysis.

A system for performing dialysis event prediction by employing a meta-training strategy for model personalization including a dual-channel combiner network (DCCN) is presented. The system includes a memory and one or more processors in communication with the memory configured to, in a meta-training stage, generate, via a task generator, segments from temporal records of patient dialysis data stored on a hospital database, generate, from the segments, a support set being a first subset of the patient dialysis data and a query set being a second subset of the patient dialysis data for each patient of a plurality of patients, formulate tasks for each patient of the plurality of patients in a pre-training set defined as a meta-training framework DCCN (M-DCCN) stored on a server or cloud platform, wherein each task includes the support set and the query set, and each task represents the patient dialysis data of each patient of the plurality of patients, and send the tasks to a two-level meta-training algorithm supported training coordinator. The system further includes, in a finetuning and evaluation stage, a memory and one or more processors in communication with the memory configured to send the M-DCCN to local machines where a finetuning dataset is collected for new patients, the finetuning dataset including a limited amount of data pertaining the new patients, fine-tune the M-DCCN for personalization to each of the new patients, and use the fine-tuned M-DCCN for future predictive dialysis analysis of future new patients by generating prognostic predictive scores on an incidence of dialysis events during dialysis.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIGS. 1A-1B illustrate a block/flow diagram of an exemplary framework for the M-DCCN system including a meta-training stage (FIG. 1A) and a fine-tuning and evaluation stage (FIG. 1B), in accordance with embodiments of the present invention;

FIGS. 2A-2B illustrate a block/flow diagram of an exemplary architecture of the M-DCCN system of FIGS. 1A-1B, in accordance with embodiments of the present invention;

FIG. 3 is a block/flow diagram illustrating a sample generation of the preprocessing component, in accordance with embodiments of the present invention;

FIG. 4 is a block/flow diagram illustrating a support set and a query set, in accordance with embodiments of the present invention;

FIG. 5 is a block/flow diagram illustrating the workflow of the M-DCCN system, in accordance with embodiments of the present invention;

FIG. 6 is a block/flow diagram illustrating the meta-training module components and the pre-training module components of the M-DCCN system, in accordance with embodiments of the present invention;

FIG. 7 is a block/flow diagram illustrating the functions of the M-DCCN preprocessing component and the M-DCCN meta-training component, in accordance with embodiments of the present invention;

FIG. 8 is a block/flow diagram illustrating the functions of the M-DCCN computational component and the M-DCCN model storage component, in accordance with embodiments of the present invention;

FIG. 9 is a block/flow diagram illustrating the functions of the M-DCCN local data collection component and the M-DCCN fine-tuning component, in accordance with embodiments of the present invention;

FIG. 10 is an exemplary practical application for performing dialysis event prediction by employing a meta-training strategy for model personalization including a dual-channel combiner network (DCCN), in accordance with embodiments of the present invention;

FIG. 11 is an exemplary processing system for performing dialysis event prediction by employing a meta-training strategy for model personalization including a dual-channel combiner network (DCCN), in accordance with embodiments of the present invention; and

FIG. 12 is a block/flow diagram of an exemplary method for performing dialysis event prediction by employing a meta-training strategy for model personalization including a dual-channel combiner network (DCCN), in accordance with embodiments of the present invention.

### DETAILED DESCRIPTION OF PREFERRED EMBODIMENTS

Given the availability of big medical data, it is beneficial to develop artificial intelligence (AI) systems for making prognostic prediction scores during the pre-dialysis period on the incidence of events in future dialysis, which can largely facilitate the decision-making processes of medical staff, and hence reduce the risk of dialysis events.

Certain challenges prevent modern AI systems from being successfully applied for precise analysis of medical data of patients, that is, due to the privacy of data, it is usually difficult to obtain a large amount of patient data from hospitals that is sufficient for training an accurate model, and due to the high variety of the population among patients, it is difficult for a single pre-trained model (trained on a set of historical patients' data) to be accurate for every new patient, who may be different in age, gender, genetics, health conditions, and so on. As such, a single pre-trained model that is trained on a limited training dataset is often not generalizable for predictive analysis on new patients' data.

The exemplary embodiments of the present invention seek to harness the potential of management data of dialysis patients providing automatic and high-quality prognostic prediction scores on the incidence of events during dialysis. In particular, the exemplary embodiments of the present invention aim to address the above-mentioned challenges by leveraging a small or limited amount of recording data of every new patient for generalizing a pre-trained model to the data distribution of that new patient, so that every new patient obtains a personalized or customized model that is particularly accurate for that patient.

Additionally, since new patients often don't have much recorded data, it is important to only use a small or limited amount of their data for model personalization or customization. Thus, it is also challenging to obtain accurate and well personalized models by “learning from small data.” The present invention addresses this challenge by leveraging the techniques of meta-learning and few-shot learning and is devised to have a meta-pre-training strategy for learning a model that is well positioned in the parameter space. Such a meta-trained model particularly fits quick finetuning with a small or limited amount of data and performs well in the personalized domain.

Specifically, dialysis patients have a regular routine of dialysis sessions with a frequency of 3 times per week. Each session takes, e.g., about 4 to 5 hours. The problem to solve is to predict the possibility of the incidence of events in a near future dialysis session for each patient based on past recording data. The recording data of dialysis patients mainly includes static profiles of the patients (e.g., age, gender, starting time of dialysis, etc.), dialysis measurement records (with a frequency of 3 times/week, e.g., blood pressure, weight, venous pressure, etc.), blood test measurements (with a frequency of 2 times/month, e.g., albumin, glucose, platelet count, etc.), and cardiothoracic ratio (CTR, with a frequency of 1 time/month). The last three parts are dynamic and change over time, so they can be modeled by time series, but with different frequencies.

Therefore, the present invention is a meta-training framework on AI systems, built upon a building block architecture of dual-channel neural networks referred to as a dual-channel combiner network (DCCN), which integrates the different parts of the data for model training and prognostic score predictions. The innovation of the exemplary embodiments of the present invention is a meta-training framework that is particularly useful for leveraging a small or limited amount of data for personalizing DCCN for every new patient. Thus, the present invention is named M-DCCN.

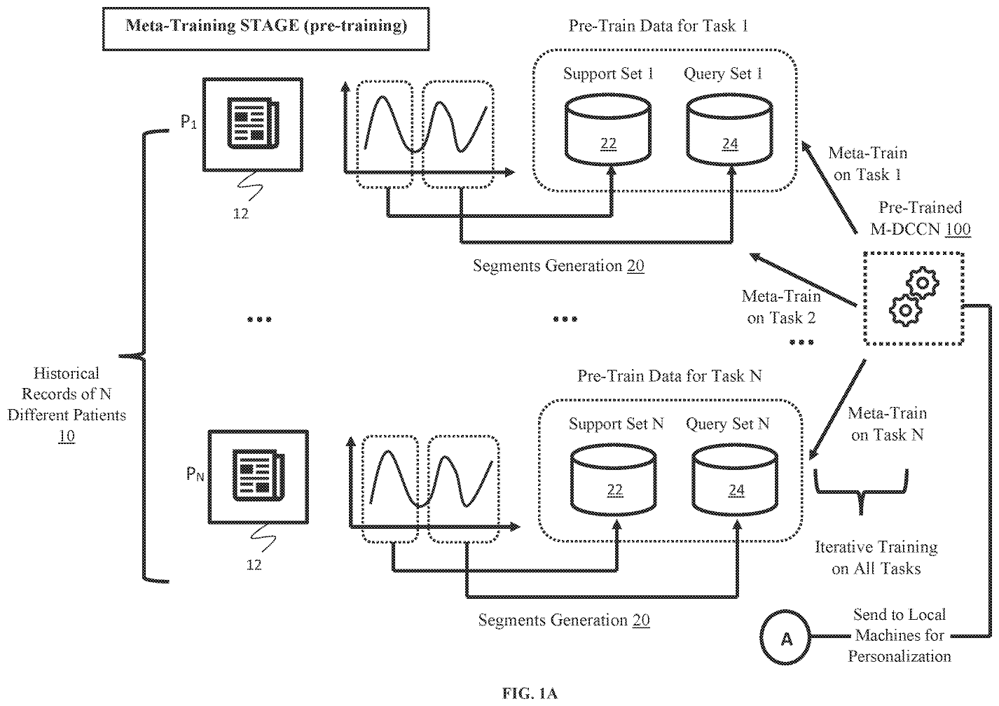

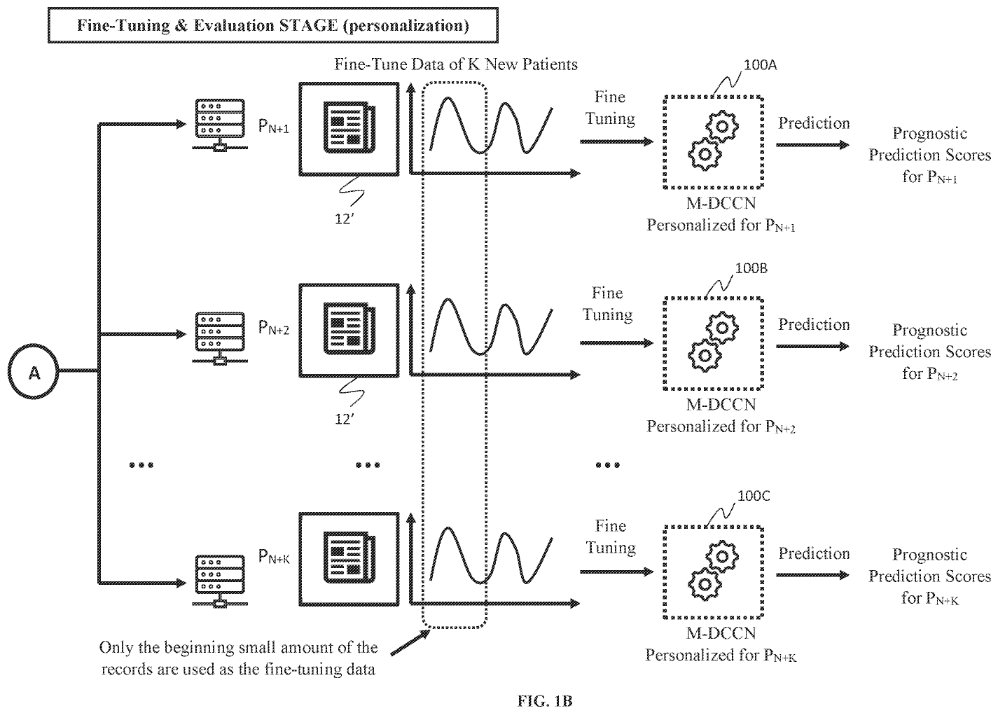

FIGS. 1A-1B illustrate a block/flow diagram of an exemplary framework for the M-DCCN system including a meta-training stage (FIG. 1A) and a fine-tuning and evaluation stage (FIG. 1B), in accordance with embodiments of the present invention.

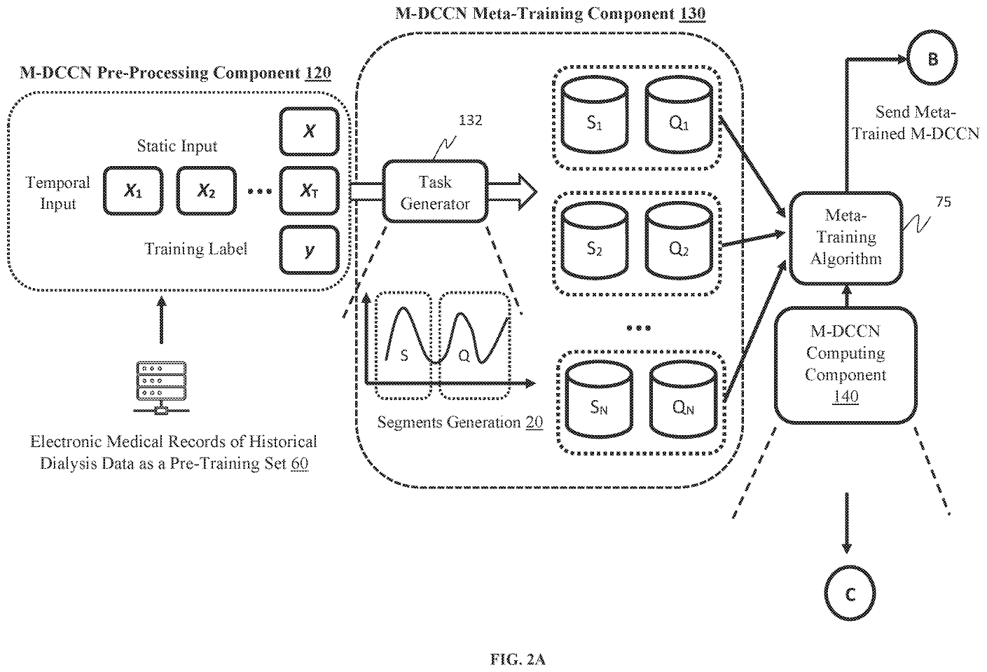

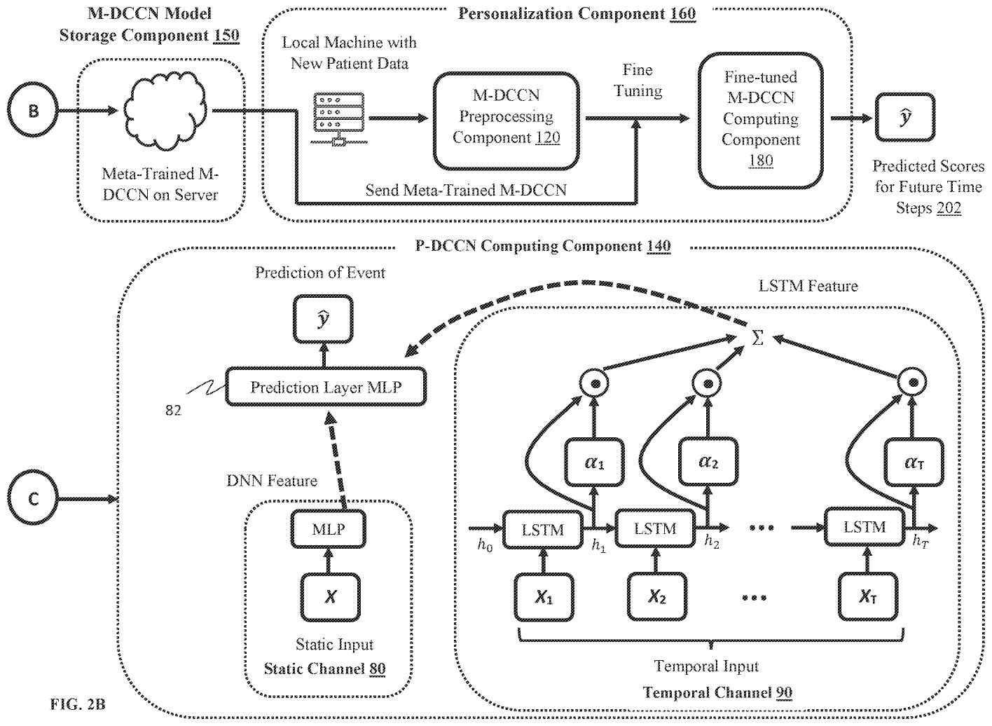

At the meta-training stage (FIG. 1A), M-DCCN system 100 is trained on the historical record data 10 of a certain number of patients stored in a database (e.g., hospital databases). The uniqueness of the M-DCCN system 100 lies in its formulation of an iterative task-wise pretraining strategy. Suppose there are N patients in the pretraining dataset. As illustrated in FIGS. 1A-1B, M-DCCN 100 has a component to generate segments 20 from the temporal records of each patient's data 12 and uses a certain proportion of the beginning segments as the support set 22, and the remaining segments as the query set 24. In this manner, N tasks are formulated for the N patients in the pretraining set. Each task has a support set 22 and a query set 24. The M-DCCN 100 has a two-level meta-training algorithm 75 (FIG. 2A) that iteratively updates its model parameters by utilizing the support and query sets 22, 24 of each task. After the meta-training is done, the pre-trained M-DCCN 100 is stored on a server or cloud platform. At the finetuning stage (FIG. 1B), once a new patient has accumulated a certain amount (which is a small or limited amount) of records 12′, such as several weeks of records, these records are used to finetune the meta-trained M-DCCN 100 for personalization. Then the personalized model (100A, 110B, 100C) can be used for future predictive analysis of this particular patient, which is usually more accurate than a model without personalization or with a regular pre-training strategy. It is noteworthy that this M-DCCN paradigm fits dialysis analysis because once started, dialysis is usually performed for a long time, e.g., many years, for a patient. Thus, the M-DCCN system 100 can be continuously finetuned and personalized for improved accuracy.

It is also worthy to mention that the M-DCCN system 100 is general and can be applied to other medical record data with a similar format illustrated in FIGS. 1A-1B.

FIGS. 2A-2B illustrate a block/flow diagram of an exemplary architecture of the M-DCCN system 100 of FIGS. 1A-1B, in accordance with embodiments of the present invention.

The components include an M-DCCN data preprocessing component 120, M-DCCN meta-training component 130, M-DCCN computing component 140, M-DCCN model storage component 150, and M-DCCN model personalization component 160.

Regarding the M-DCCN data preprocessing component 120, the historical records 60 of dialysis patients can be stored in a database. Each patient has a file that includes information on static profile, dialysis measurements, blood test measurements, and event incidences. Each row indicates a particular date of a hospital visit by the patient. Each column indicates a particular feature, such as some indicator metrics in the dialysis measurements (e.g., blood pressure, weight, venous pressure, etc.). Since different parts have different frequencies, some entries in the form can be blank indicating that feature is not measured at a particular date.

The data preprocessing component 120 extracts different parts of the data from the files, removes noisy information, and fills in some missing values by using mean values of the corresponding features in the historical data or by using values from adjacent earlier time steps.

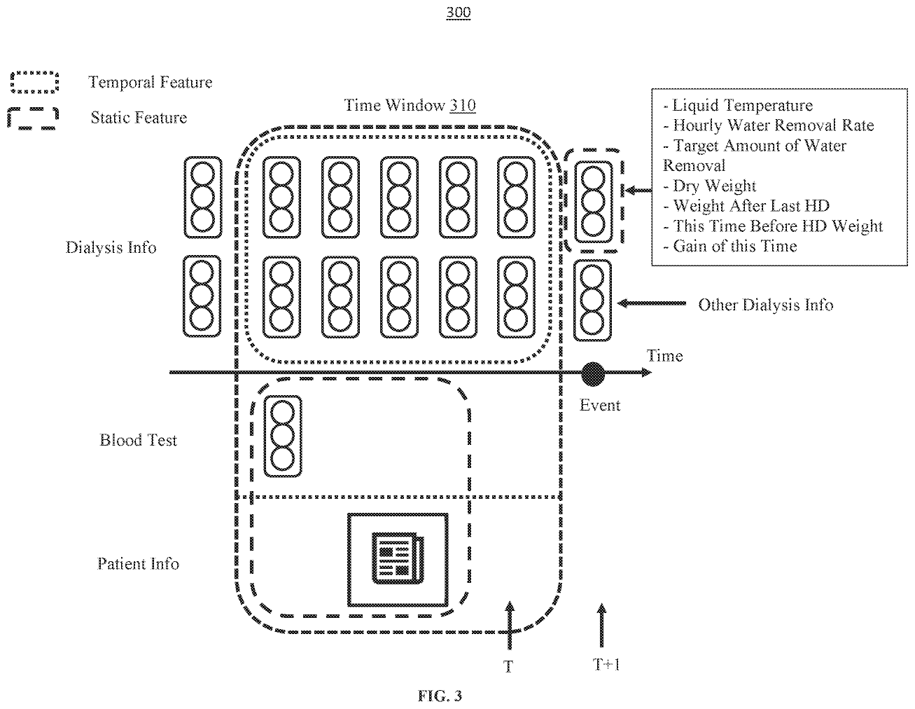

Moreover, the data preprocessing component 120 sets up a time window 310 (FIG. 3) of width w to segment the time series data. FIG. 3 illustrates the segmentation process 300. Each time window 310 generates a sample X from time step T−w to time step T, and associates it with an event label Y at time step T+1. The purpose is to generate samples focused on the features in the closest dates to a future event. Because different parts have different frequencies, all dialysis measurements in the time window 310 will be included, while the blood test measurements on the closest date to the time window 310 will be included. Then the time window 310 will slide from the beginning of the date to the end of the date in the records to generate multiple samples.

Some of the dialysis measurements are evaluated on the same date for which event is to be predicted. These measurements are evaluated immediately before the dialysis starts. Thus, they can be included as static features as illustrated by the boxed features on the upper right corner.

After samples are generated, the data preprocessing component 120 normalizes all samples by using a Gaussian normalization method such that the features of the training samples have a mean of 0 and a variance of 1, which facilitates the stability of the computing algorithm in the next steps. For testing samples, they are normalized by using the mean and variance obtained from the training data. Then, the normalized samples are sent to the next component for model training and testing.

Regarding the M-DCCN meta-training component 130, the M-DCCN meta-training component 130 includes two modules, that is, a task generator 132 and a meta-training algorithm supported training coordinator 75.

Regarding the task generator 132, the M-DCCN meta-training component 130 considers or represents each patient's data as a task. The model is pre-trained iteratively from task to task so that the knowledge shared by different tasks can be extracted, and quickly adapted to new tasks. This is similar in a manner that a human quickly learns to deal with a new task by leveraging the knowledge learned from other relevant tasks.

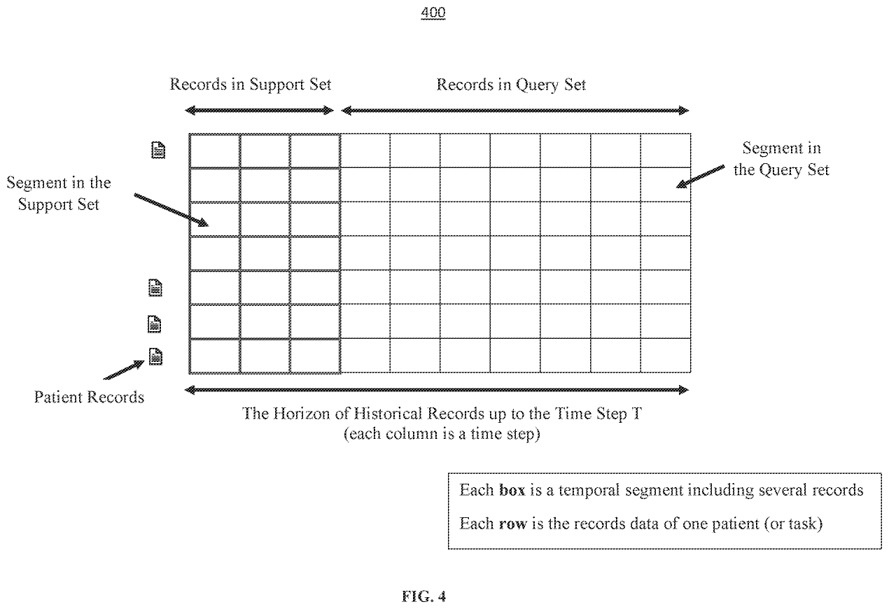

The task generator 132 is responsible for organizing the patients' data in the training set into the format of tasks. Each task includes two subsets of data of one patient, a support set, and a query set. FIG. 4 illustrates an example 400 of how to generate support sets and query sets for each patient (or task). Specifically, the historical records of each patient are arranged from the earliest time step 1 to the newest time step T. Then segments are generated by sliding a window from time step 1 to T, with a window size w and stride 1. Thus, each segment contains w records. The support set constitutes the beginning Z% part of the segments, and the query set constitutes the last (1-Z)% part of the segments. In practice, Z% is a small percentage (e.g., 30%), such that the model is meta-trained in the few-shot scenario. Models trained as such can quickly adapt to a new task in the testing phase by leveraging a small or limited amount of the data of the new task.

As such, suppose there are N patients in the training set, N tasks are constructed, where every task has a support set and query set for the meta-training algorithm to coordinate.

As illustrated by FIGS. 2A-2B, the input to this module are the N task data (support set and query set) and the model to be trained. The steps of the meta-training algorithm in this module are illustrated below.

| • | Input: M-DCCN computing component, support sets, query sets | |
|---|---|---|
| • | While not done do | |
| | • | Sample a batch of patients (tasks) from the pre-training set |
| | • | For each patient (task) in the batch do |

| | |
|---|---|
| • | Inner gradient descent of M-DCCN computing component on |
| | the support set (the first Z% segments) |

| | |
|---|---|
| • | End for |
| • | Outer gradient descent of M-DCCN computing component on the |
| | query set (the last (1-Z)% segments) |

| | |
|---|---|
| • | End while |
| • | Output: trained M-DCCN computing component |

The algorithm is two-level. The coordinator 75 first samples a batch of tasks from the N tasks in the pre-training set. This sampling process will repeat and iterate so that a comprehensive part of all tasks can be covered, which constitutes the outer iteration. For each sampled batch, the coordinator 75 iterates the model from task to task in this batch, which constitutes the inner iteration.

In the inner iteration, the M-DCCN computing component 140 performs gradient descent on the support set 22 only to obtain task-specific model parameters θᵢ(i=1, . . . N)

θᵢ=θ−α∇_{θ}Lᵢ(f_{θ})

where θ is the general model parameter (not task-specific), and f_{θ} represents the M-DCCN computing component, Lᵢ(f_{θ}) is the loss function on the i-th task support set, and α is the gradient step size.

Specifically, for the loss function, the exemplary methods use a regression loss function

$$L = \frac{1}{D} {\sum }_{j = 1}^{D} {‖ {\hat{y}}_{j} - {y}_{j} ‖}_{2}^{2} + λ {‖ θ ‖}_{2}^{2}$$

where D is the number of samples in the dataset, and yⱼ is the true indicator of the incidence of an event for the j-th sample in the training data. It is 1 if there is an event, and 0 otherwise. ŷⱼ is the predicted score for the j-th sample. ŷⱼ is the output of the M-DCCN computing component 140. That is ŷⱼ=f_{θ}(xⱼ) , where xⱼ is the corresponding input to the computing component 140. In the above equation, λ is a hyperparameter to control the regularization on model parameters to avoid overfitting during the training process. The optimization is performed, e.g., by using an Adam optimizer.

After all tasks are iterated in the batch, the coordinator collects all task-specific parameters θ₁, . . . , θ_{N}, and performs an outer gradient decent to update the general model parameter θ:

θ=θ−β∇_{θΣiϵbatch}Lᵢ(f_{θ}_{ᵢ})

where β is another gradient step size.

In this manner, the general model parameter θ will be updated toward a position that can quickly adapt to different tasks by leveraging a small or limited amount of data in the support set.

The output of this module is the trained M-DCCN computing component (with model parameter θ), which is sent to the model storage component for future personalization in local machines.

Regarding the M-DCCN computing component 140, the M-DCCN computing component 140 primarily includes two channels, a static channel 80 for processing static and low frequency temporal features and a temporal channel 90 for processing high frequency temporal features.

Regarding the static channel 80, suppose the static features (and low frequency temporal features) are represented by a vector xₛ, the static channel 80 has a multilayer perceptron (MLP) to encode the information in xₛ to a compact representation hₛ by:

hₛ=f_{MLP}(xₛ)

where f_{MLP}(⋅) can be multiple layers of fully connected network with the form Wₛxₛ+bₛ, with Wₛ and bₛ as the model parameters to be trained.

After this step, the output hₛ will be a compact representation of the static features, which will be integrated with the representations from temporal channels for prediction.

Regarding the temporal channel 90, the temporal channel 90 includes several Long Short-Term Memory (LSTM) layers for processing the temporal features. Suppose the temporal features are represented by a sequence of vectors x₁, . . . , x_{T}, then the LSTM layers will output a sequence of compact representations h₁, . . . , h_{T} by:

h₁, . . . , h_{T}=f_{LSTM}(x₁, . . . , x_{T})

where f_{LSTM}(⋅) can have multiple layers of LSTM units, which includes trainable model parameters. Also, the LSTM units can be extended to a bi-directional LSTM to encode information from both temporal directions.

On top of the LSTM layers, h₁, . . . , h_{T} will be sent to an attention layer for combination. The attention layer calculates a temporal importance score, e.g., attention weight αₜ, for each time step by:

eₜ=w_{α}tanh (W_{α}hₜ) for t=1, . . . , T

αₜ=softmax(eₜ) for t=1, . . . , T

where W_{α} and w_{α} are model parameters to learn. After this step, Σₜ₌₁^{T}αₜ=1.

All compact temporal representations are combined through the attention weights by:

$${h}_{d} = {\sum }_{t = 1}^{T} {α}_{t} {h}_{t}$$

and h_{d} is the compact representation for all temporal features x₁, . . . , x_{T}, and is the output of the temporal channel.

Regarding the prediction layer 82, after the static and temporal representations hₛ and h_{d} are obtained from the static channel 80 and temporal channel 90, the prediction layer 82 concatenates them and computes the probability of events through an MLP by:

ŷ=f_{MLP}([hₛ, h_{d}])

where ŷ is a score which indicates the probability of the incidence of a dialysis event.

Regarding the M-DCCN model storage component 150, after the M-DCCN model 100 is meta-trained through the meta-training component 130, it (together with all parameters updated and fixed) is sent to a server or a cloud platform for storage, so that it can be easily distributed to local machines for further finetuned and personalized using a small or limited number of records from new patients that are collected by the local machines.

Regarding the M-DCCN personalization component 160, in practice, when a new patient has performed dialysis for several weeks, the local machine collects several records for that patient during the time. Although the number of records is much smaller than the data size in the pre-training dataset, these records are specific to the particular patient and are valuable to adapt the globally pre-trained model to the contexts of the particular patient. This personalization process via a small or limited amount of finetuning data leverages the advantages of the few-shot learning. M-DCCN is meta-trained specifically for leveraging a small or limited amount of data for quick adaptation.

The following steps are conducted in component 160:

The meta-trained M-DCCN 100 is sent to the local machine where the finetune dataset is collected and stored.

The finetune dataset is sent to the M-DCCN preprocessing component 120 for generating training samples. The meta-trained M-DCCN is fine-tuned using, e.g., an Adam optimizer with the regression loss function:

$${l = \frac{1}{{D}^{′}} {\sum }_{j = 1}^{{D}^{′}} ‖ {\hat{y}}_{j} - {y}_{j} ‖}_{2}^{2} + λ {‖ θ ‖}_{2}^{2}$$

where D′ represents the total number of samples in the finetuning set.

Once the finetuning 180 is done, the personalized model M-DCCN 160 is used to predict future events of a particular patient by using the patient's historical records data. Predictions 202 obtained in this manner are often significantly better than a model without pre-training or using the pre-trained model directly because the model is adapted to the particular patient's data so that the distribution discrepancy between the particular patient's data and the data of the pre-training set is alleviated.

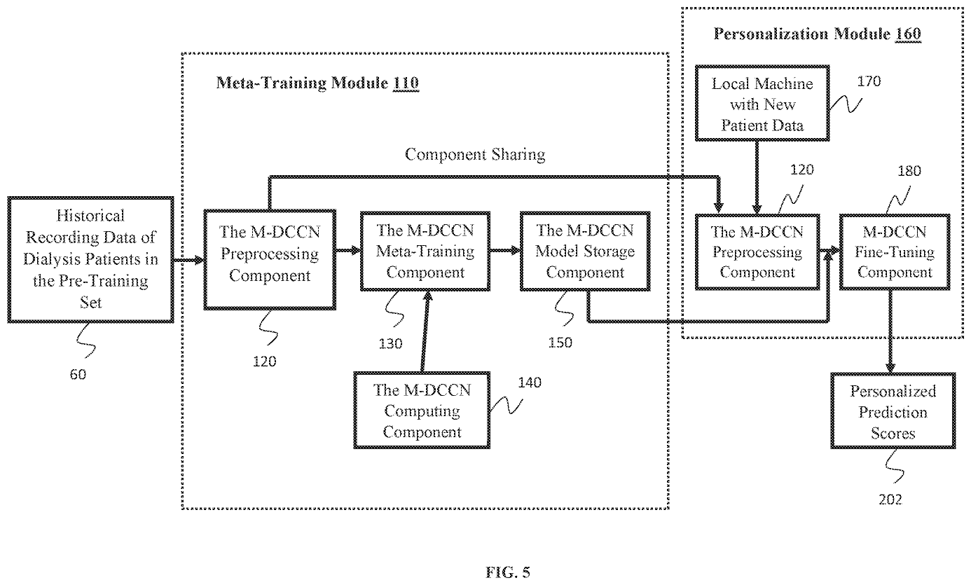

FIG. 5 is a block/flow diagram illustrating the workflow of the M-DCCN system, in accordance with embodiments of the present invention.

Regarding the meta-training M-DCCN module 110:

Historical recording data 60 of patients is input into the M-DCCN data preprocessing component 120 and normalized samples are output as the meta-training set.

The normalized samples are sent and input, together with the M-DCCN computing component model parameters 140, to the M-DCCN meta-training component 130 for task generation and iterative meta-training, for updating M-DCCN model parameters, and the meta-trained M-DCCN is output.

The meta-trained M-DCCN is sent to the model storage component 150 for future deployment and personalization in local machines.

Regarding the fine-tuning M-DCCN module 160:

The small or limited amount of collected data is input into a local machine 170 to the M-DCCN data preprocessing component 120 and normalized samples are output as the finetuning set.

The meta-trained M-DCCN is sent from the model storage component 150 to the M-DCCN personalization component 160.

The model parameters (via 180) of the meta-trained M-DCCN are finetuned with several training iterations using the finetuning dataset.

The finetuned M-DCCN is used to for generating personalized prediction scores ŷ (202) on the personal data from the local machines

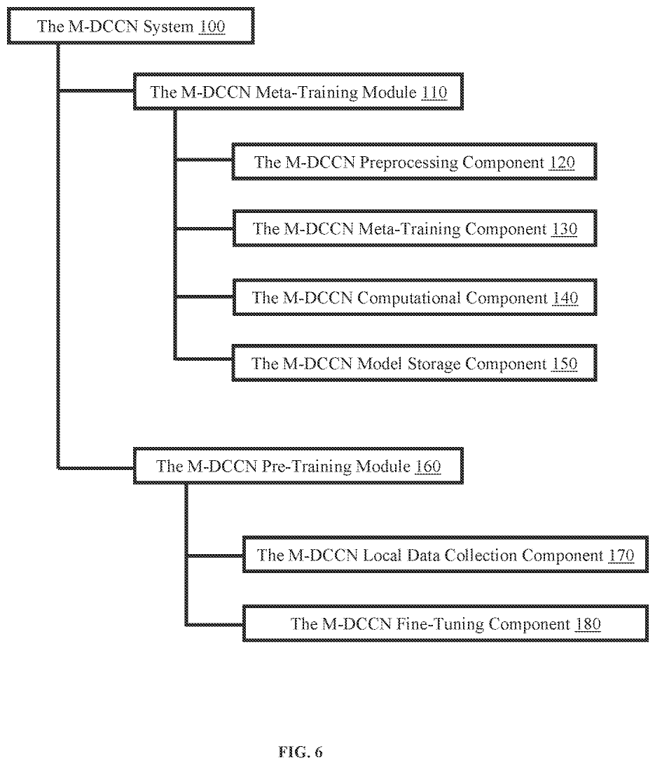

FIG. 6 is a block/flow diagram illustrating the meta-training module components and the pre-training module components of the M-DCCN system, in accordance with embodiments of the present invention.

The M-DCCN system 100 includes the M-DCCN meta-training module 110 and the M-DCCN pre-training module 160.

The M-DCCN meta-training module 110 includes the M-DCCN preprocessing component 120, the M-DCCN meta-training component 130, the M-DCCN computational component 140, and the M-DCCN model storage component 150.

The M-DCCN pre-training module 160 includes the M-DCCN local data collection component 170 and the M-DCCN fine-tuning component 180.

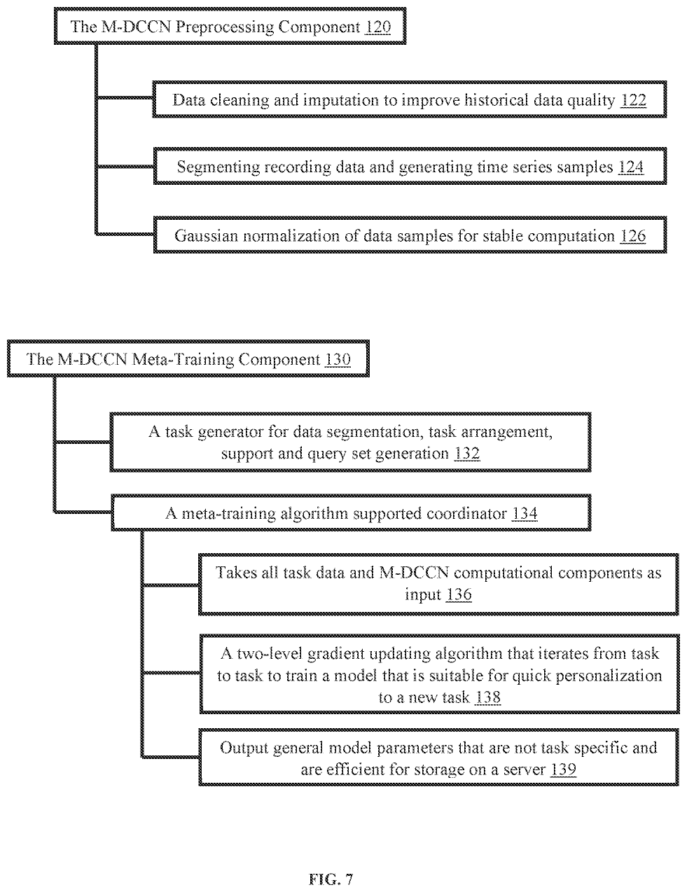

FIG. 7 is a block/flow diagram illustrating the functions of the M-DCCN preprocessing component and the M-DCCN meta-training component, in accordance with embodiments of the present invention.

The M-DCCN preprocessing component 120 involves data cleaning and imputation 122 to improve historical data quality, segmenting recording data and generating time series samples 124, and Gaussian normalization 126 of data samples for stable computation.

The M-DCCN meta-training component 130 involves a task generator 132 for data segmentation, task arrangement, support and query set generation, and a meta-training algorithm supported coordinator 134.

The meta-training algorithm supported coordinator 134 involves taking all tasks data and M-DCCN computational components as input 136, employing a two-level gradient updating algorithm 138 that iterates from task to task to train a model that is suitable for quick personalization to a new task, and outputting 139 general model parameters that are not task specific and are efficient for storage on a server.

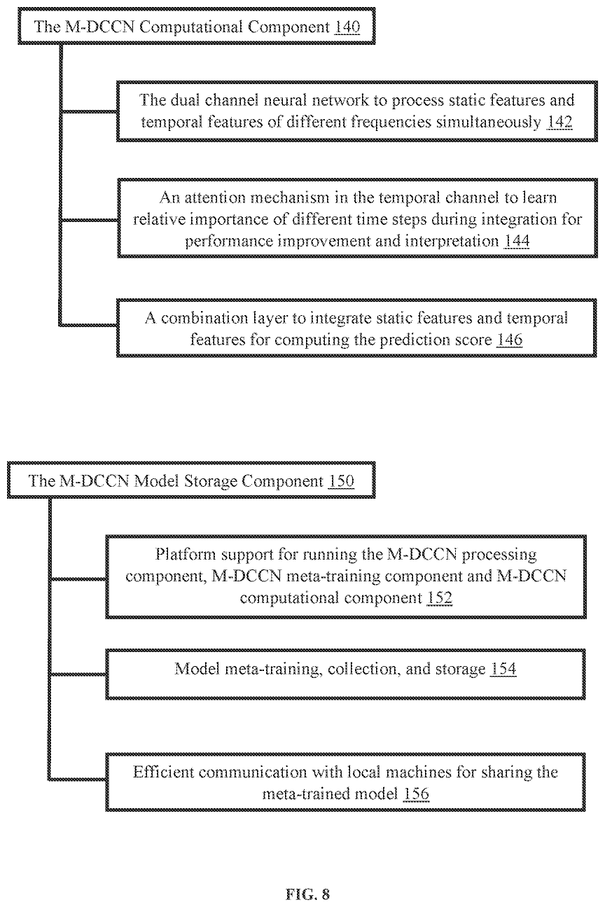

FIG. 8 is a block/flow diagram illustrating the functions of the M-DCCN computational component and the M-DCCN model storage component, in accordance with embodiments of the present invention.

The M-DCCN computational component 140 involves employing a dual channel neural network 142 to process static features and temporal features of different frequencies simultaneously, employing an attention mechanism 144 in the temporal channel to learn relative importance of different time steps during integration for performance improvement and interpretation, and employing a combination layer 146 to integrate static features and temporal features for computing the prediction score.

The M-DCCN model storage component 150 involves platform support 152 for running the M-DCCN processing component, the M-DCCN meta-training component, and the M-DCCN computational component, employing model meta-training, collection, and storage 154, and employing efficient communication 156 with local machines for sharing the meta-trained model.

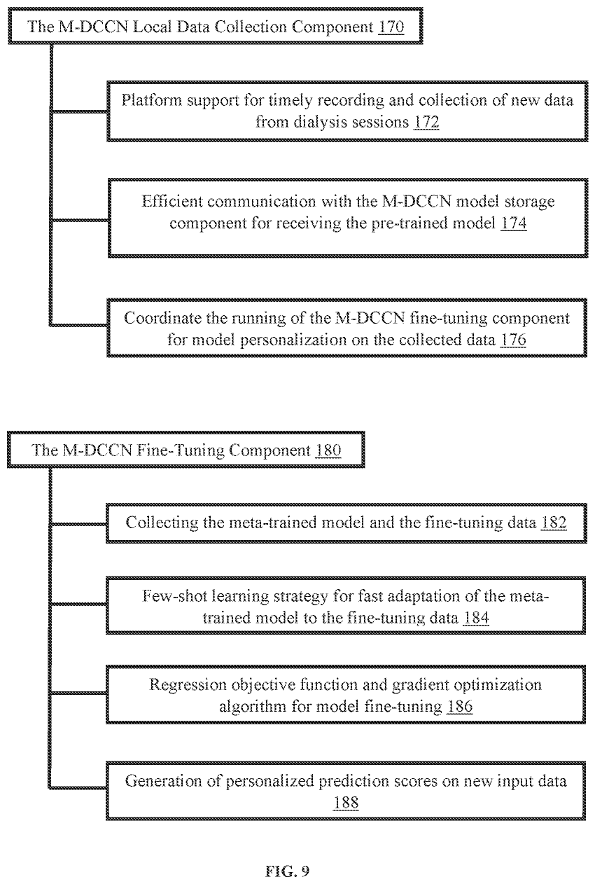

FIG. 9 is a block/flow diagram illustrating the functions of the M-DCCN local data collection component and the M-DCCN fine-tuning component, in accordance with embodiments of the present invention.

The M-DCCN local data collection component 170 involves platform support 172 for timely recording and collection of new data from dialysis sessions, employing efficient communication 174 with the M-DCCN model storage component for receiving the pre-trained model, and coordinating 176 the running of the M-DCCN fine-tuning component for model personalization on the collected data.

The M-DCCN fine-tuning component 180 involves collecting 182 the meta-trained model and the fine-tuning data, employing a few-shot learning strategy 184 for fast adaptation of the meta-trained model to the fine-tuning data, employing a regressive objective function and gradient optimization algorithm 186 for model fine-tuning, and generating 188 personalized prediction scores on the new input data.

In conclusion, compared to conventional art, the exemplary M-DCCN system provides a systematic and data driven solution to the dialysis event prediction problem with several advancements, that is:

The M-DCCN system is a neural network based intelligent computing system that does not require much human efforts on feature engineering.

The M-DCCN system has a dual-channel component for integrating static features, low frequent temporal features, and high frequent temporal features for joint representation learning and the prediction of dialysis events.

The M-DCCN system formulates tasks from historical data for meta-training and has a meta-training strategy with a two-level algorithm that learns a model that is well positioned in the parameter space. A model that is such trained can quickly fit a new task with a small or limited amount of data and perform well in the personalized domain.

The M-DCCN addresses and alleviates the challenges of insufficient training data, and the distribution discrepancy of patient data, and thus provides better accuracy than models without personalization or with a regular pre-training strategy.

Consequently, there have been a couple of neural network models for processing electronic healthcare record (EHR) data. These methods have demonstrated the superior performance of recurrent neural networks such as LSTM and GRU in modeling the EHR data. However, these methods are not designed as a solution to the problem of dialysis event prediction. Compared to these methods, the exemplary M-DCCN system's dual-channel component, meta-training component, and personalization component are designed specifically as an intelligent system for processing dialysis recording data. The M-DCCN system provides a systematic solution to the problem on dialysis event prediction.

The inventive features of the exemplary embodiments include the framework of meta-training and personalization of the M-DCCN system for dialysis event prediction where the meta-training component of the M-DCCN system on historical records of certain amounts of patient data generates a meta-trained model that is stored on a server or cloud platform to be used for future new patient predictive analysis. The task generator and two-level meta-training algorithms inside the meta-training component for learning a M-DCCN model can quickly leverage a small or limited amount of data for personalization and domain adaptation. The personalization component of the M-DCCN system sends the meta-trained model to local devices where new patients' records are stored for finetuning. This component only uses a small or limited number of new records. With such a small amount of data for personalization, the model can achieve significant improvement of accuracy compared to other non-personalized approaches or regularly pre-trained models.

The dialysis recording data processing component of the M-DCCN system transforms the historical records of each patient into static profile features and time series features of different frequencies, which are input to M-DCCN computing component. The deep neural network design of the M-DCCN computing component improves prediction accuracy and reduces human efforts on feature engineering. The dual-channel design of the M-DCCN computing component, which includes a multilayer perceptron (MLP) and a LSTM recurrent neural network, integrated both static features and temporal features of different frequencies for joint event prediction.

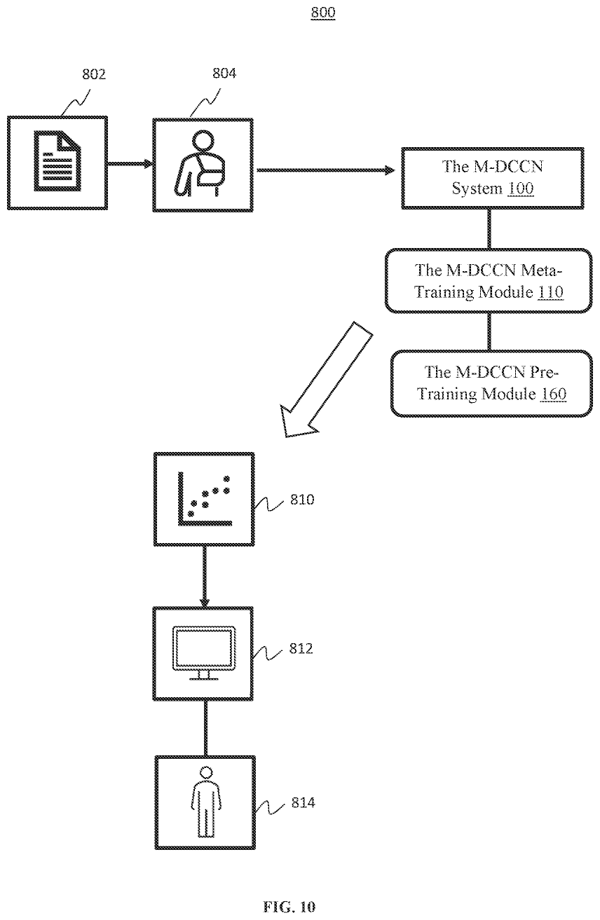

FIG. 10 is a block/flow diagram 800 of a practical application for performing dialysis event prediction by employing a meta-training strategy for model personalization including a dual-channel combiner network (DCCN), in accordance with embodiments of the present invention.

In one practical example, records 802 of patients 804 are processed by the M-DCCN system 100 via a M-DCCN meta-training module 110 and a M-DCCN pre-training module 160. The results 810 (e.g., variables or parameters or factors or features or records or medical data) can be provided or displayed on a user interface 812 handled by a user 814.

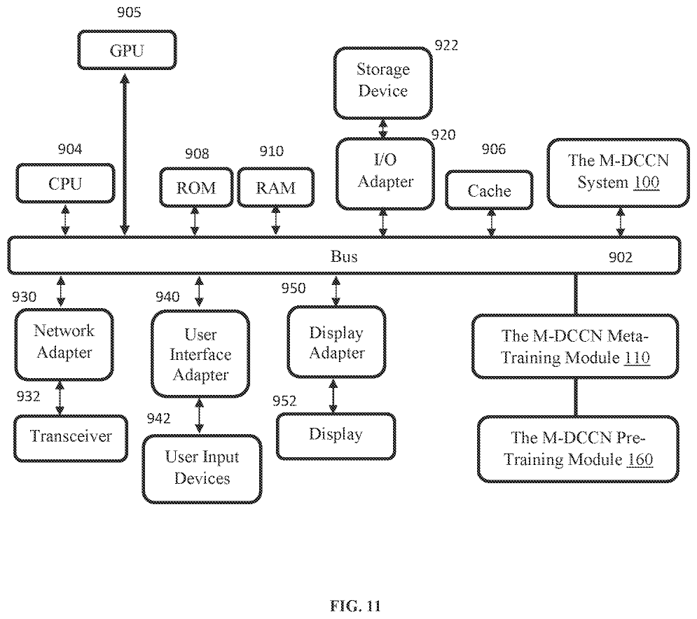

FIG. 11 is an exemplary processing system for performing dialysis event prediction by employing a meta-training strategy for model personalization including a dual-channel combiner network (DCCN), in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, the M-DCCN system 100 includes a M-DCCN meta-training module 110 and a M-DCCN pre-training module 160.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

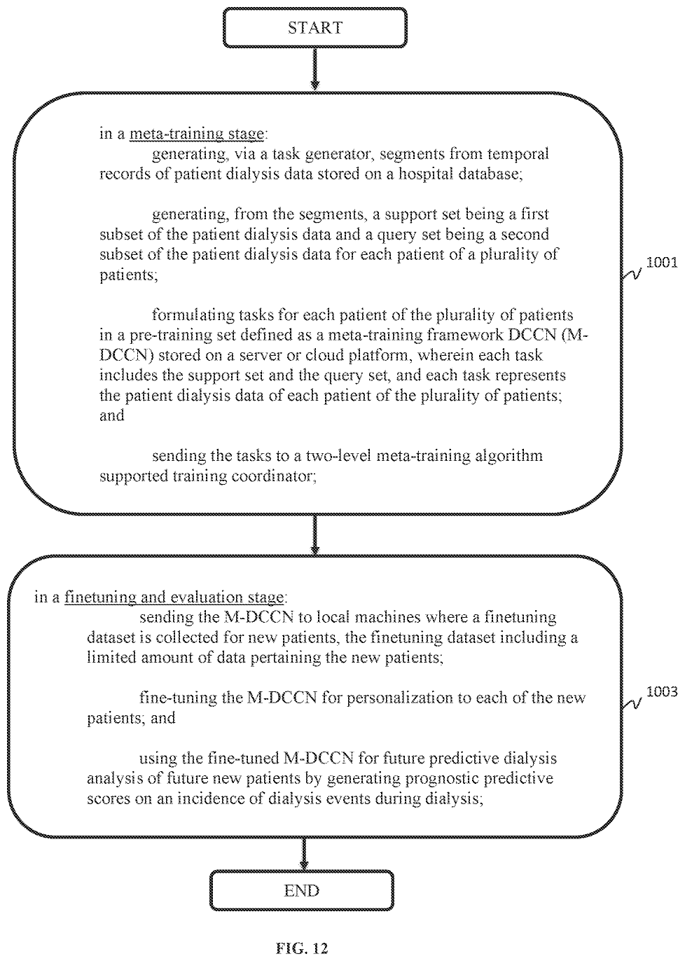

FIG. 12 is a block/flow diagram of an exemplary method for performing dialysis event prediction by employing a meta-training strategy for model personalization including a dual-channel combiner network (DCCN), in accordance with embodiments of the present invention.

At block 1001, in a meta-training stage, generate, via a task generator, segments from temporal records of patient dialysis data stored on a hospital database, generate, from the segments, a support set being a first subset of the patient dialysis data and a query set being a second subset of the patient dialysis data for each patient of a plurality of patients, formulate tasks for each patient of the plurality of patients in a pre-training set defined as a meta-training framework DCCN (M-DCCN) stored on a server or cloud platform, wherein each task includes the support set and the query set, and each task represents the patient dialysis data of each patient of the plurality of patients, and send the tasks to a two-level meta-training algorithm supported training coordinator.

At block 1003, in a finetuning and evaluation stage, send the M-DCCN to local machines where a finetuning dataset is collected for new patients, the finetuning dataset including a limited amount of data pertaining the new patients, fine-tune the M-DCCN for personalization to each of the new patients, and use the fine-tuned M-DCCN for future predictive dialysis analysis of future new patients by generating prognostic predictive scores on an incidence of dialysis events during dialysis.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave.

Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for performing dialysis event prediction by employing a meta-training strategy for model personalization including a dual-channel combiner network (DCCN), the method comprising:
in a meta-training stage:
generating, via a task generator, segments from temporal records of patient dialysis data stored on a hospital database;
generating, from the segments, a support set being a first subset of the patient dialysis data and a query set being a second subset of the patient dialysis data for each patient of a plurality of patients;
formulating tasks for each patient of the plurality of patients in a pre-training set defined as a meta-training framework DCCN (M-DCCN) stored on a server or cloud platform, wherein each task includes the support set and the query set, and each task represents the patient dialysis data of each patient of the plurality of patients; and
sending the tasks to a two-level meta-training algorithm supported training coordinator; and
in a finetuning and evaluation stage:
sending the M-DCCN to local machines where a finetuning dataset is collected for new patients, the finetuning dataset including a limited amount of data pertaining the new patients;
fine-tuning the M-DCCN for personalization to each of the new patients; and
using the fine-tuned M-DCCN for future predictive dialysis analysis of future new patients by generating prognostic predictive scores on an incidence of dialysis events during dialysis.

2. The method of claim 1, wherein the two-level meta-training algorithm supported training coordinator performs an outer iteration and an inner iteration.

3. The method of claim 2, wherein, for the outer iteration, the two-level meta-training algorithm supported training coordinator iteratively samples batches of the tasks in the M-DCCN.

4. The method of claim 2, wherein, for the inner iteration, task-specific model parameters are obtained by performing a gradient descent on the support set only.

5. The method of claim 1, wherein the two-level meta-training algorithm supported training coordinator communicates with a M-DCCN computing component including a static channel for processing static and low frequency temporal features and a temporal channel for processing high frequency temporal features.

6. The method of claim 5, wherein the M-DCCN computing component further includes a prediction layer for concatenating static representations obtained from the static channel with temporal representations obtained from the temporal channel to compute a probability of dialysis events through a multilayer perceptron (MLP).

7. The method of claim 1, wherein a few-shot learning strategy is employed for adaptation of the M-DCCN to the finetuning dataset.

8. A non-transitory computer-readable storage medium comprising a computer-readable program for performing dialysis event prediction by employing a meta-training strategy for model personalization including a dual-channel combiner network (DCCN), wherein the computer-readable program when executed on a computer causes the computer to perform the steps of:
in a meta-training stage:
generating, via a task generator, segments from temporal records of patient dialysis data stored on a hospital database;
generating, from the segments, a support set being a first subset of the patient dialysis data and a query set being a second subset of the patient dialysis data for each patient of a plurality of patients;
formulating tasks for each patient of the plurality of patients in a pre-training set defined as a meta-training framework DCCN (M-DCCN) stored on a server or cloud platform, wherein each task includes the support set and the query set, and each task represents the patient dialysis data of each patient of the plurality of patients; and
sending the tasks to a two-level meta-training algorithm supported training coordinator; and
in a finetuning and evaluation stage:
sending the M-DCCN to local machines where a finetuning dataset is collected for new patients, the finetuning dataset including a limited amount of data pertaining the new patients;
fine-tuning the M-DCCN for personalization to each of the new patients; and
using the fine-tuned M-DCCN for future predictive dialysis analysis of future new patients by generating prognostic predictive scores on an incidence of dialysis events during dialysis.

9. The non-transitory computer-readable storage medium of claim 8, wherein the two-level meta-training algorithm supported training coordinator performs an outer iteration and an inner iteration.

10. The non-transitory computer-readable storage medium of claim 9, wherein, for the outer iteration, the two-level meta-training algorithm supported training coordinator iteratively samples batches of the tasks in the M-DCCN.

11. The non-transitory computer-readable storage medium of claim 9, wherein, for the inner iteration, task-specific model parameters are obtained by performing a gradient descent on the support set only.

12. The non-transitory computer-readable storage medium of claim 8, wherein the two-level meta-training algorithm supported training coordinator communicates with a M-DCCN computing component including a static channel for processing static and low frequency temporal features and a temporal channel for processing high frequency temporal features.

13. The non-transitory computer-readable storage medium of claim 12, wherein the M-DCCN computing component further includes a prediction layer for concatenating static representations obtained from the static channel with temporal representations obtained from the temporal channel to compute a probability of dialysis events through a multilayer perceptron (MLP).

14. The non-transitory computer-readable storage medium of claim 8, wherein a few-shot learning strategy is employed for adaptation of the M-DCCN to the finetuning dataset.

15. A system for performing dialysis event prediction by employing a meta-training strategy for model personalization including a dual-channel combiner network (DCCN), the system comprising:
a memory; and
one or more processors in communication with the memory configured to:
in a meta-training stage:
generate, via a task generator, segments from temporal records of patient dialysis data stored on a hospital database;
generate, from the segments, a support set being a first subset of the patient dialysis data and a query set being a second subset of the patient dialysis data for each patient of a plurality of patients;
formulate tasks for each patient of the plurality of patients in a pre-training set defined as a meta-training framework DCCN (M-DCCN) stored on a server or cloud platform, wherein each task includes the support set and the query set, and each task represents the patient dialysis data of each patient of the plurality of patients; and
send the tasks to a two-level meta-training algorithm supported training coordinator; and
in a finetuning and evaluation stage:
send the M-DCCN to local machines where a finetuning dataset is collected for new patients, the finetuning dataset including a limited amount of data pertaining the new patients;
fine-tune the M-DCCN for personalization to each of the new patients; and
use the fine-tuned M-DCCN for future predictive dialysis analysis of future new patients by generating prognostic predictive scores on an incidence of dialysis events during dialysis.

16. The system of claim 15, wherein the two-level meta-training algorithm supported training coordinator performs an outer iteration and an inner iteration.

17. The system of claim 16, wherein, for the outer iteration, the two-level meta-training algorithm supported training coordinator iteratively samples batches of the tasks in the M-DCCN.

18. The system of claim 16, wherein, for the inner iteration, task-specific model parameters are obtained by performing a gradient descent on the support set only.

19. The system of claim 15, wherein the two-level meta-training algorithm supported training coordinator communicates with a M-DCCN computing component including a static channel for processing static and low frequency temporal features and a temporal channel for processing high frequency temporal features.

20. The system of claim 19, wherein the M-DCCN computing component further includes a prediction layer for concatenating static representations obtained from the static channel with temporal representations obtained from the temporal channel to compute a probability of dialysis events through a multilayer perceptron (MLP).
